(19) United States
(12) Patent Application Publication
(10) Pub. No.: US 2003/0184812 A1
(43) Pub. Date: Oct. 2, 2003

(54) Image processing apparatus and method

(75) Inventors: Jun Minakuti, Osaka (JP); Atsushi Ueda, Osaka (JP)

Correspondence Address: McDERMOTT, WILL & EMERY, 600 13th Street, N.W., Washington, DC, 20005, US

(73) Assignee: MINOLTA CO., LTD.

(21) Appl. No.: 10/388,623

(22) Filed: Mar. 17, 2003

(30) Foreign Application Priority Data
Apr. 1, 2002 (JP) P2002-098643

(51) Int. Cl. H04N 1/21; H04N 1/23

(52) U.S. Cl. 358/296; 358/302

(57) ABSTRACT

The present invention provides an image processing technique capable of determining input image data obtained by a digital camera and generating output image data which can be visually outputted with equivalent tone and color characteristics even from a different output device from the input image data in consideration of tone characteristics. An application AP stored in a storing unit 15 is loaded into a memory 10b, and a control unit 10 is activated as an image processing apparatus. After that, when input image data is inputted from any one of a digital camera 3, a storing medium 4a and a scanner 5 to the control unit 10 via an input/output I/F 21, in the case where it is determined that a device which has obtained the input image data is the digital camera on the basis of predetermined input information such as information accompanying the input image data or information inputted by the user, the input image data is transformed to lightness and chromaticity information and tone transformation for enhancing the contrast of a lightness range from shadow to middle tone is performed without changing lightness, thereby generating output image data.

This application is based on application No. 2002-098643 filed in Japan, the contents of which are hereby incorporated by reference.

### BACKGROUND OF THE INVENTION

1. Field of the Invention

The present invention relates to an image processing technique of generating output image data on the basis of input image data of a subject obtained by a predetermined device.

2. Description of the Background Art

Conventionally, there is a color management system for transforming an image obtained by any of various image input devices so that colors of an original image are accurately reproduced and outputting the transformed image. As such a color management system, for example, there is known a color management system for transforming image data obtained by a flat bed scanner or a film scanner and outputting the resultant image data to a monitor or a printer.

In the color management system, in order to calorimetrically reproduce colors of an original image with accuracy, it is necessary to design so that the tone characteristic of image data between an input side and an output side becomes linear and further to perform a color transforming process in a linear color space. Therefore, in the color management system, a process of transforming a nonlinear tone characteristic adapted to an input device to a linear tone characteristic is performed on image data which is inputted (input image data), a color transforming process corresponding to a colorimetric system of the input device and a colorimetric system of the output device, which are different from each other, is performed. After that, the resultant image data is corrected to have a nonlinear tone characteristic so as to be adapted to the output device, and the corrected image data is outputted.

When an original image on the input side and a reproduced image on the output side (an image on a monitor or an image on a print) have dynamic ranges (ranges of luminance and density) which are almost equal to each other and compared with each other under similar observation conditions, the design of the color management system is very suitable.

In the case of a system using a real scene as an original image, the dynamic range of the real scene and that of a reproduced image are largely different from each other, and the observation condition of the real scene and that of the reproduced image are also largely different from each other. It is generally known that, in the color management system for capturing a real scene and reproducing the captured image, in order to reproduce the colors of the original image (real scene) visually better, it is necessary to intentionally make the tone characteristic nonlinear and to make the contrast of a reproduced image higher than that of the original.

Therefore, in the case of capturing an image by a camera for a silver halide film, the contrast of a real scene recorded by the camera onto a silver halide film is set to be higher than the actual contrast. In the case of capturing an image by a digital camera, image data is subjected to tone transformation in the digital camera and it is set so that the contrast of a reproduced image is higher than that of an original image.

In the case where an image obtained by a camera for a silver halide film is processed by a conventional color management system, when a scanner obtains an image from a silver halide film, image data is obtained from the silver halide film on which an image whose contrast has been already enhanced is recorded. Consequently, the colors of the original image can be reproduced accurately.

In the case where an image obtained by a digital camera is processed by a conventional color management system, however, a process of transforming a nonlinear tone characteristic to a linear tone characteristic is performed on image data. Consequently, a tone characteristic of the image data, intentionally set to be nonlinear in the digital camera, is transformed to a linear tone characteristic and the resultant image data is outputted. As a result, an effect of enhancing the contrast is lost. Therefore, in the conventional color management system, in the case of reproducing an image captured by a digital camera, compatibility between tone reproduction and color reproduction cannot be satisfied.

As described above, the conventional color management system cannot be applied to an image obtained by a digital camera. Consequently, for example, Japanese Patent Application Laid-Open No. 7-222196 (1995) discloses a color management system for performing a process of transforming image data in accordance with visual environment information in order to perform color reproduction of an image transferred between a scanner and a CRT or printer. Japanese Patent Application Laid-Open No. 8-292735 (1996) discloses a color management system for transforming image data into lightness and chromaticity information and transforming the lightness information in order to perform color reproduction between an output of a printer and an output of a CRT.

In the former color management system in the above-described color management systems, however, since transformation of image data is performed on the basis of visual environment information, in the case where there is no visual environment information, proper color reproduction cannot be performed. Since a device which has obtained input image data cannot be determined, in the case where input image data is obtained by a digital camera, output image data which can be visually outputted with equivalent tone and color characteristic even from a different output device cannot generated from the input image data in consideration of tone characteristics of the input image data.

The latter color management system cannot perform image data transformation which enhances contrast. The system performs a similar lightness information transforming process on all of input image data and cannot determine the device which has obtained the input image data. Consequently, in the case where input image data is obtained by a digital camera, output image data which can be visually outputted with equivalent tone and color characteristic even from a different output device in consideration of the tone characteristic of input image data cannot be generated from input image data.

### SUMMARY OF THE INVENTION

The present invention is directed to an image processing apparatus for generating output image data on the basis of input image data from an external device.

According to the present invention, the image processing apparatus comprises: a determining part for determining whether the external device is a digital camera or not on the basis of predetermined input information; a transforming part for transforming the input image data into lightness and chromaticity information when the external device is determined as a digital camera by the determining part; and a generating part for generating the output image data by performing tone transformation for enhancing contrast in a specific lightness range on the lightness and chromaticity information without changing chromaticity.

When it is determined on the basis of predetermined input information that a device which has obtained input image data is a digital camera, the input image data is transformed into lightness and chromaticity information, and tone transformation for enhancing contrast in a specific lightness range without changing chromaticity is performed, thereby generating output image data. Consequently, in the case where input image data is obtained by a digital camera, output image data which can be visibly outputted with equivalent tone and color characteristics even from a different output device can be generated from the input image data in consideration of the tone characteristic of the input image data.

According to a preferred aspect of the present invention, the generating part performs tone transformation for enhancing contrast in a lightness range from shadow to middle tone.

Since the contrast in the lightness range from shadow to middle tone is enhanced, image data which can be visibly outputted with equivalent tone and color characteristics even from a different output device can be generated from the input image data obtained by the digital camera.

According to another preferred aspect of the present invention, the generating part performs tone transformation on the basis of tone characteristic information which is inputted from the outside of the image processing apparatus.

Since tone transformation is performed on the basis of tone characteristic information which is inputted from the outside, tone transformation adapted to tone characteristics of input image data which varies according to the model which has obtained input image data can be performed.

According to still another preferred aspect of the present invention, the generating part performs tone transformation on the basis of tone characteristic information stored in the image processing apparatus.

Since tone transformation is performed on the basis of tone characteristic information stored in the image processing apparatus, intended tone transformation can be carried out without receiving tone characteristic information from the outside. Also in the case of using a general image format, a general ICC profile or the like, intended tone transformation can be performed.

According to another aspect of the present invention, the image processing apparatus comprises: a determining part for determining whether the external device is a specific device or not on the basis of predetermined input information; a transforming part for transforming the input image data into first image information and second image information when the external device is determined as the specific device by the determining part; and a generating part for generating the output image data from the image information by modifying the second image information without changing the first image information.

When input image data is obtained by a specific device, output image data which can be visibly outputted with equivalent tone and color characteristics even from a different output device can be generated from the input image data in consideration of the tone characteristic of the input image data.

The present invention is also directed to a computer program product capable of making a computer built in an image processing apparatus for generating output image data on the basis of input image data from an external device execute a process.

The present invention is also directed to an image processing method of generating output image data on the basis of input image data from an external device.

Therefore, an object of the present invention is to provide an image processing technique capable of determining input image data obtained by a specific device and generating output image data which can be visibly outputted with equivalent tone and color characteristics even from a different output device from the input image data in consideration of the tone characteristic of the input image data.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an outline of main components of an image processing system according to an embodiment of the present invention;

FIG. 2 is a schematic diagram showing places where tone characteristic information exist;

FIG. 3 is a flowchart for describing operation of an image process;

FIG. 4 is a flowchart for describing operation of the image process;

FIG. 5 is a flowchart for describing operation of the image process;

FIG. 6 is a flowchart for describing operation of the image process;

FIG. 7 is a flowchart for describing operation of the image process;

FIG. 8 is a flowchart for describing operation of the image process;

FIG. 9 is a flowchart for describing operation of the image process;

FIG. 10 is a schematic diagram showing a setting dialog for setting conditions of an image process or the like;

FIG. 11 is a schematic diagram showing a part of the structure of stored contents of profile information;

FIG. 12 is a schematic diagram showing a part of stored contents of an input image file; and

FIG. 13 is a schematic diagram showing tone characteristic information used for transforming lightness information.

### DESCRIPTION OF THE PREFERRED EMBODIMENTS

Hereinafter, embodiments of the present invention will be described with reference to the drawings.

Outline of Main Components of Image Processing System 1

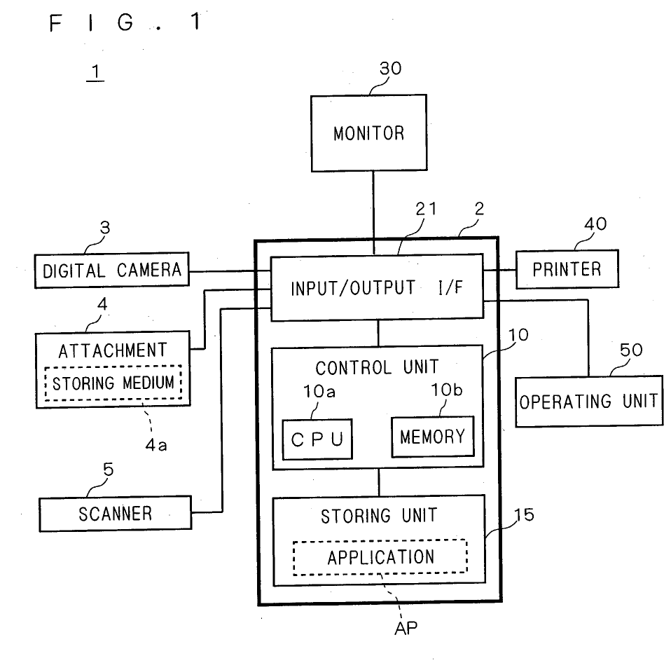

FIG. 1 shows an outline of main components of an image processing system 1 according to an embodiment of the present invention.

The image processing system 1 has: a personal computer 2 capable of receiving data from a digital camera 3, an attachment 4 and a scanner 5 each for inputting image data via communication cables; a monitor 30 and a printer 40 which are connected to the personal computer 2 so as to receive data from the personal computer 2; and an operating unit 50 used by the user to input various selection items and the like to the personal computer 2.

The personal computer 2 has a control unit 10, a storing unit 15 and an input/output I/F 21.

The input/output I/F 21 is an interface for transmitting/receiving data to/from the digital camera 3, attachment 4, scanner 5, monitor 30, printer 40 and operating unit 50 and transmits/receives data to/from the control unit 10.

The storing unit 15 takes the form of, for example, a hard disk or the like and stores an application (software) AP or the like which will be described later.

The control unit 10 has a CPU 10a and a memory 10b and is a part for performing centralized control on the components of the personal computer 2. An application (program) stored in the storing unit 15 is loaded to the memory 10b of the control unit 10 and executed by the CPU 10a, thereby enabling an image process (which will be described later) to be performed. The control unit 10 functions as an “image processing apparatus”. Herein, tone transformation is executed on the basis of tone characteristic information which will be described later.

The digital camera 3 is a general digital camera. A storing medium 4a can be attached to the attachment 4, and the attachment 4 transmits image data or the like stored in the storing medium 4a to the input/output I/F 21.

The scanner 5 is a general film scanner in which a color photographic film or the like on which density of a dye is recorded by photographing by a camera for a silver halide film is set, obtains image data, and transmits the image data to the input/output I/F 21.

The monitor 30 takes the form of, for example, a CRT and can display an image based on output image data generated by the control unit 10.

The printer 40 prints an image based on output image data generated by the control unit 10.

The operating unit 50 is constructed by a keyboard, a mouse and the like, and transmits various electric signals to the input/output I/F 21 in accordance with various operations of the user. Place Where Tone Characteristic Information Exists

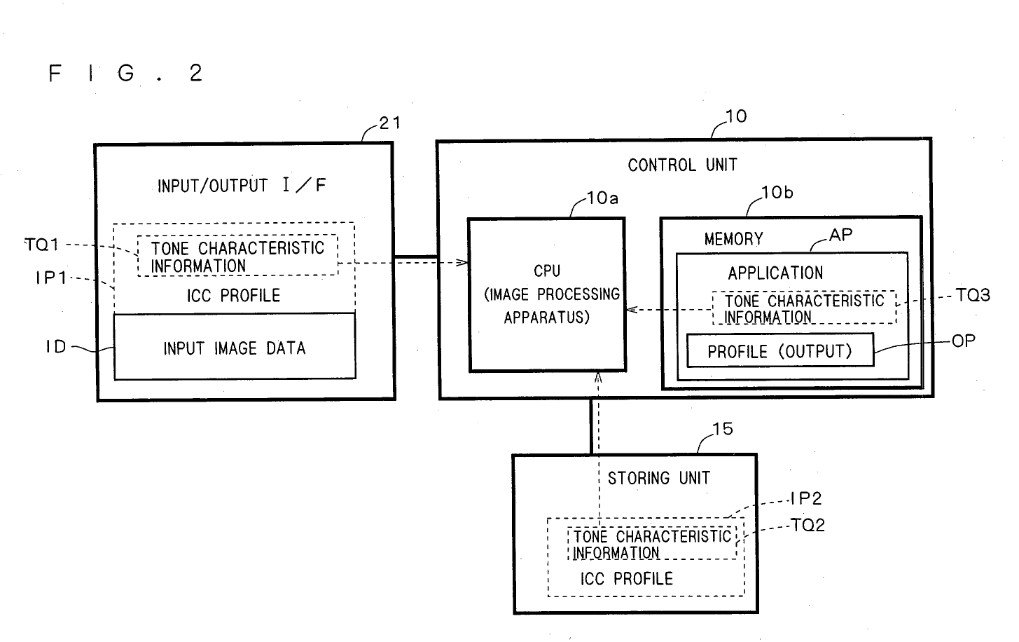

FIG. 2 is a schematic diagram showing places where tone characteristic information exist, which is used for transforming a tone characteristic (tone transformation) at the time of loading the application AP stored in the storing unit 15 to the memory 10b in the control unit 10 and performing an image process by the CPU 10a. FIG. 2 therefore shows a state where the application AP is stored in the memory 10b and input image data ID is inputted to the control unit 10 via the input/output I/F 21.

As shown in FIG. 2, with respect to a place where tone characteristic information exists, there are the following three patterns: (1) a case where an ICC profile IPI according to the format of the ICC (International Color Consortium) accompanies the input image data ID and tone characteristic information TQ1 corresponding to the model of a digital camera obtaining the input image data ID (the model obtaining an image) exists in the ICC profile IP1 (for example, a case where the ICC profile IP1 is stored in header information of an input image file including the input image data ID); (2) a case where an ICC profile IP2 corresponding to the model obtaining an image is stored in the storing unit 15 and tone characteristic information TQ2 exists in the ICC profile IP2; and (3) a case where tone characteristic information TQ3 exists in the application.

In correspondence with various cases such as the case where tone characteristic information exists at least in one of the three places (1) to (3) and the case where the tone characteristic information exists in all of the three places, the CPU 10a performs an image process including tone transformation on the basis of the tone characteristic information existing in various places.

Herein, a profile OP corresponding to an output device exists in the application AP, although not shown, a name list of digital cameras for determining a device which has obtained input image data ID which will be described later is written in the application AP, and an ICC profile corresponding to the digital camera name list written in the application AP is stored in the storing unit 15. In the application AP, a name list or the like of devices (such as a scanner) other than the digital camera is also written. In the storing unit 15, an ICC profile corresponding to the name list of devices other than the digital cameras written in the application AP is also stored.

Hereinafter, description will be given of the operation of an image process according to the application AP in the control unit 10.

Operations of Control Unit 10 (Image Processing Apparatus)

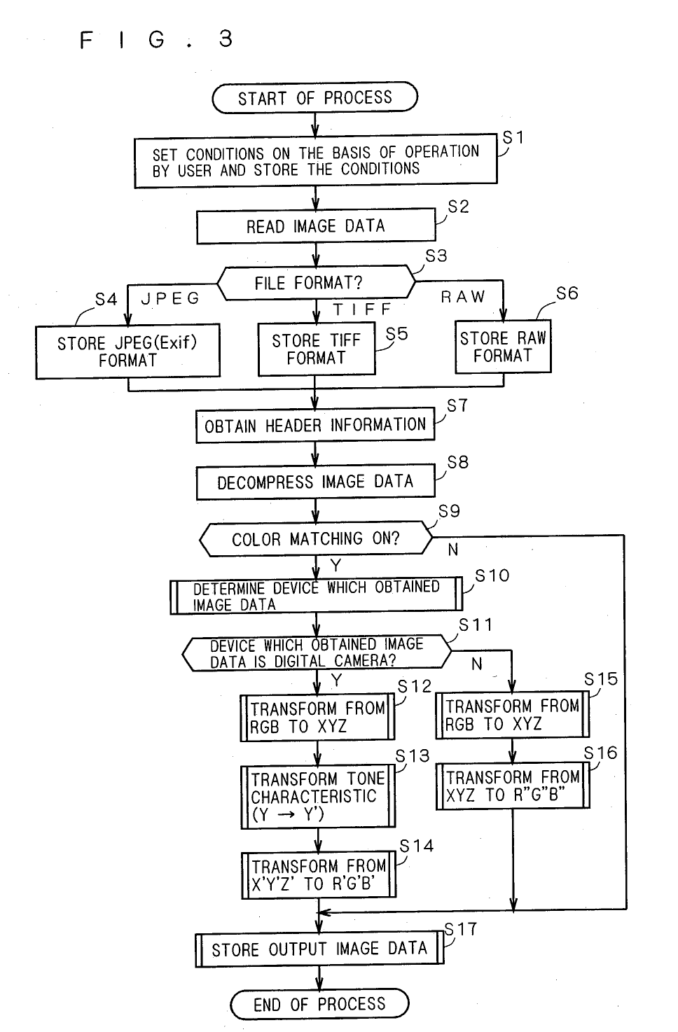

FIGS. 3 to 9 are flowcharts for describing the operation of an image process executed by the control unit 10. The operation is executed when the application AP stored in the storing unit 15 is loaded into the memory 10b in the control unit 10 and activated. It is assumed herein that, before the activation of the application AP, image data can be inputted to the input/output I/F 21 from at least one of the digital camera 3, storing medium 4a and scanner 5.

After the application AP is activated, the input image data ID is inputted from at least one of the digital camera 3, storing medium 4a and scanner 5 connected to the personal computer 2 to the control unit 10 via the input/output I/F 21 on the basis of operation of the operating unit 50 by the user, and the program advances to step S1.

In step S1, conditions of the image process and the like are displayed on the monitor 30, conditions of the image process and the like are set on the basis of various operations of the operating unit 50 by the user and stored into the memory 10b and, after that, the program advances to step S2.

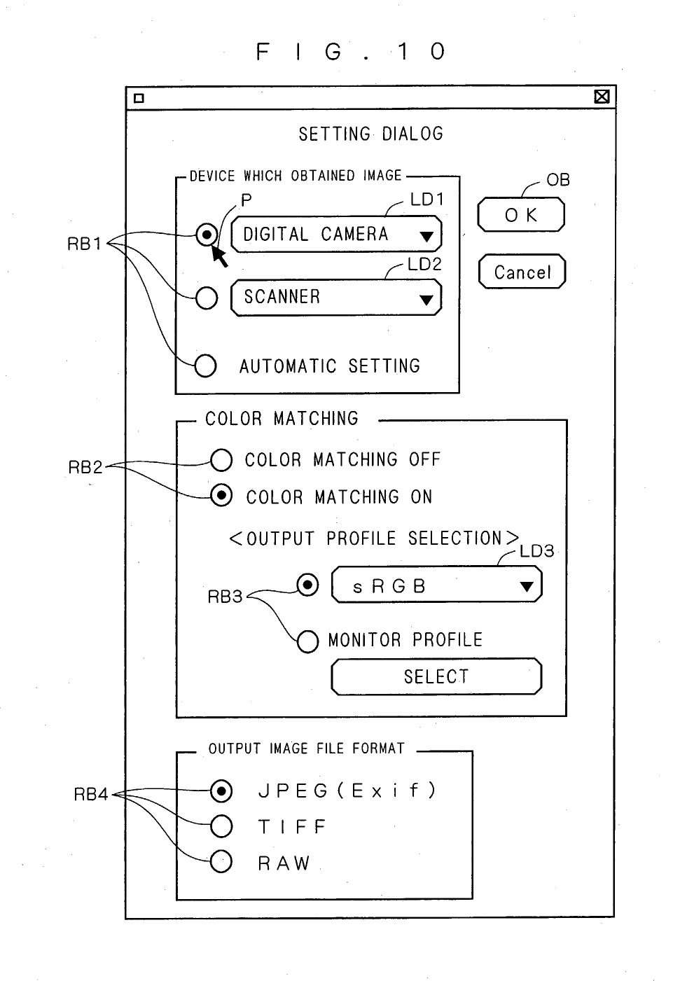

FIG. 10 shows a setting dialog for setting conditions of the image process and the like displayed on the monitor 30 in step S1. In the setting dialog, conditions of a device (image capturing device) which has obtained the input image data ID, color matching (color reproduction), and an output image file format can be set. In this example, the user can move the position of a mouse pointer P on the setting dialog with the mouse of the operating unit 50 to set any of the items on the basis of a mouse clicking operation.

Concretely, with respect to the condition of the device which has obtained the input image data ID, by selecting one radio button from a radio button group RB 1, one of “digital camera”, “scanner” and “automatic setting” can be selected. When the user knows that the device which has obtained the input image data ID is the digital camera, “digital camera” can be selected. When the user knows that the device which has obtained the input image data ID is the scanner, “scanner” can be selected. When the user does not know the device which has obtained the input image data ID, the automatic setting can be selected. Herein, although the devices which can be designated by the user are only “digital camera” and “scanner”, the devices are not limited thereto but other devices can be designated by displaying other devices in device pull-down menu display areas LD1 and LD2 selecting one of the other devices on the basis of the operation of the operating unit 50 by the user.

With respect to the condition of color matching, by selecting one radio button from a radio button group RB2, “color matching OFF” or “color matching ON” can be selected. When color matching is not performed, “color matching OFF” is selected. When color matching is performed, “color matching ON” is selected. In the case of selecting “color matching ON”, by selecting one radio button from a radio button group RB3, an output profile adapted to an output device can be selected.

As shown in FIG. 10, at the time of selecting an output profile according to the monitor 30, “monitor profile” is selected. In the case of setting another output profile, the upper button in the radio button group RB3 is selected. By the operation of the operating unit 50, the kinds of the output profiles to be set in an output profile pull-down menu LD3 are selected from output profiles prepared in the application AP and displayed. In such a manner, various output profiles can be selectively set. Herein although “monitor profile” is the output profile adapted to the monitor 30, the present invention is not limited thereto. In a case such that the kind of the monitor 30 is changed, setting of the output profile corresponding to “monitor profile” can be changed.

With respect to the condition of the output image file format, by selecting one radio button from a radio button group RB4, one of output image file formats “JPEG(Exif)”, “TIFF” and “RAW” can be selected.

By selecting an OK button OB after the selecting operation, the conditions of the image capturing device, color matching and output image file format are set.

Description will be continued by referring again to FIG. 3.

As described above, in step S1, conditions regarding the image process such as an image capturing device and color matching are set on the basis of the operation by the user and stored in the memory 10b. After that, the program advances to step S2.

In step S2, the input image data ID is read and the program advances to step S3.

In step S3, the image file format according to the read input image data ID is determined. When the file format is determined as the JPEG(Exif) format, the program advances to step S4. When the file format is determined as the TIFF format, the program advances to step S5. When the file format is determined as the RAW format, the program advances to step S6.

In step S4, it is stored in the memory 10b that the file format of the input image data ID is the JPEG(Exif) format, and the program advances to step S7.

In step S5, it is stored in the memory 10b that the file format of the input image data ID is the TIFF format, and the program advances to step S7.

In step S6, it is stored in the memory 10b that the file format of the input image data ID is the RAW format, and the program advances to step S7.

In step S7, according to the input image file format, header information of the image file is obtained and stored in the memory 10b, and the program advances to step S8. The header information obtained herein is stored in the memory 10b until output image data is outputted after the image process is finished.

In step S8, the input image data ID read in step S2 is decompressed, and the program advances to step S9. In the case where the input image file format is the RAW format, decompression is unnecessary so that the decompressing process is not performed.

In step S9, whether the color matching process is performed or not is determined. On the basis of the conditions which are set and stored in step S1, when the user selects execution of the color matching, the program advances to step S10. When the user does not select execution of the color matching, the program advances to step S117.

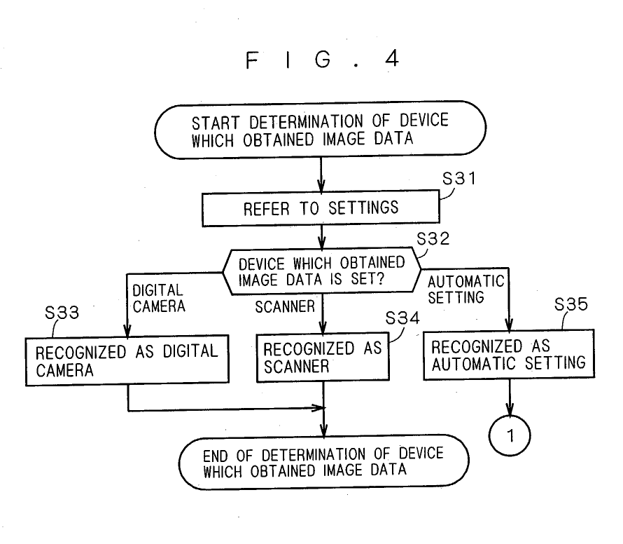

In step S10, the device which has obtained the input image data ID is determined, and the program advances to step S111. The flow of a concrete process of determining the device which has obtained the input image data ID in step S10 is shown as a separate flowchart in FIG. 4.

When the program advances from step S9 to step S10, the process of determining the image capturing device shown in FIG. 4 is started, and the program advances to step S31.

In step S31, the setting made in step S1 is read from the memory 10b and referred to, and the program advances to step S32.

In step S32, on the basis of the details referred in step S31, how the image capturing device is set in step S1 is determined. In the case where “digital camera” is set as the image capturing device in step S1, the program advances to step S33. In the case where “scanner” is set as the device in step S1, the program advances to step S34. In the case where “automatic setting” is set as the device in step S1, the program advances to step S35.

In step S33, the image capturing device is recognized as a digital camera, the process of determining the image capturing device is finished, and the program advances to step S11.

In step S34, the image capturing device is recognized as a scanner, the process of determining the image capturing device is finished, and the program advances to step S11.

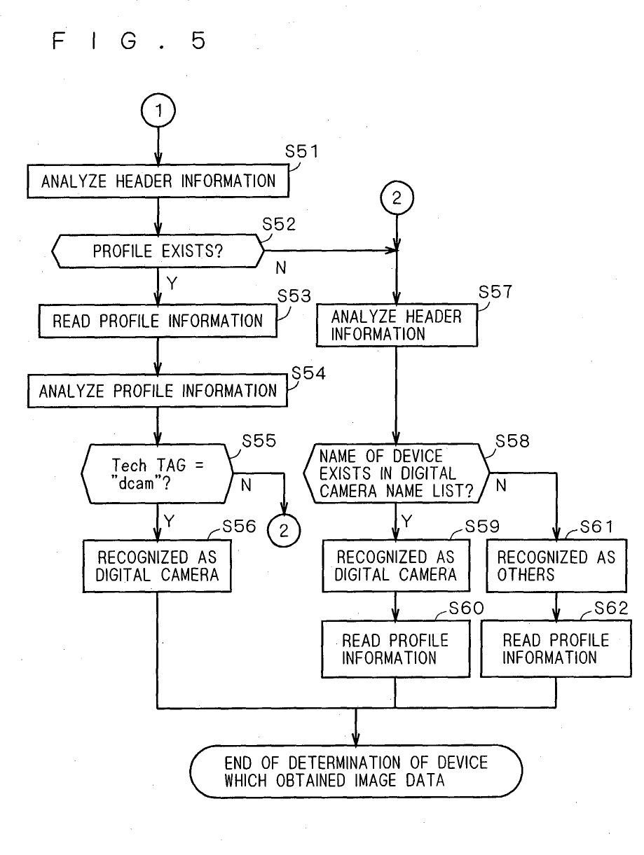

In step S35, setting of the image capturing device is recognized as automatic setting. In order to further execute the process of determining the image capturing device, the program advances to step S51 in FIG. 5.

In step S51, header information obtained in step S7 is read from the memory 10b and analyzed and the presence/absence of an ICC profile (hereinafter, referred to as “profile information”) corresponding to the input image data ID in the header information is checked, and the program advances to step S52.

In step S52, on the basis of the check made in step S51, whether profile information corresponding to the input image data ID exists in the header information or not is determined. In the case where profile information corresponding to the input image data ID exists in the tag information, the program advances to step S53. In the case where profile information corresponding to the input image data ID does not exist in the tag information, the program advances to step S57.

In step S53, the profile information corresponding to the input image data ID existing in the header information is read and the program advances to step S54.

In step S54, the profile information read in step S53 is analyzed to check information written in a Technology tag (hereinafter, referred to as Tech tag), and the program advances to step S55.

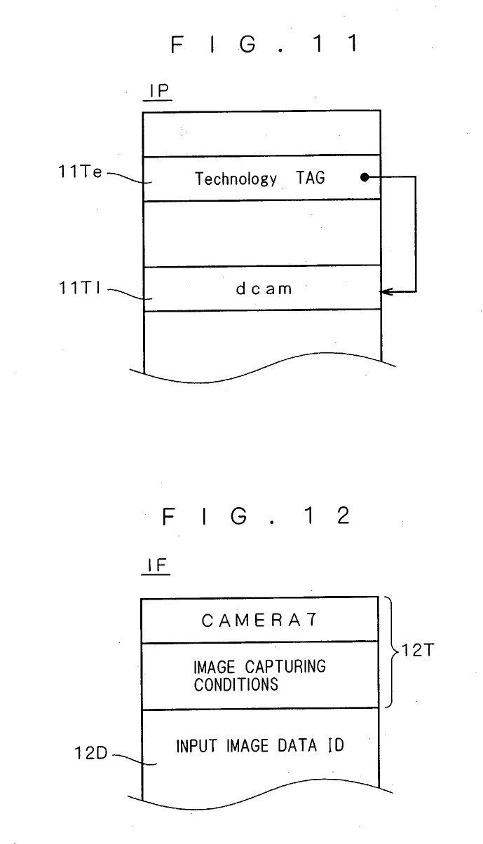

FIG. 11 is a schematic diagram illustrating a part of the structure of the stored profile information. In the case of profile information corresponding to an image captured by a digital camera, as shown in FIG. 11, for example, there is a case that information 11TI written as “dcam” exists in the address indicated in a Tech tag 11Te. That is, in step S54, by referring to the address written in the tag of the profile information, information written in the Tech tag is checked and the information written in the Tech tag area 11Te is analyzed.

In step S55, whether information written as “dcam” exists in the address indicated in the Tech tag 11Te or not is determined on the basis of a result of the analysis in step S54. If information written as “dcam” exists, the program advances to step S56. If the information written as “dcam” does not exist, the program advances to step S57.

In step S56, as determined in step S55, the information written as “dcam” exists in the address indicated in the Tech tag 11Te. Therefore, the device which has obtained the input image data ID is recognized as the digital camera, the process of determining the image capturing device is finished, and the program advances to step S11 in FIG. 3.

In step S57, the header information obtained in step S7 is read from the memory 10b and analyzed, the information regarding the device which has obtained the input image data ID in the header information is recognized, and the program advances to step S58.

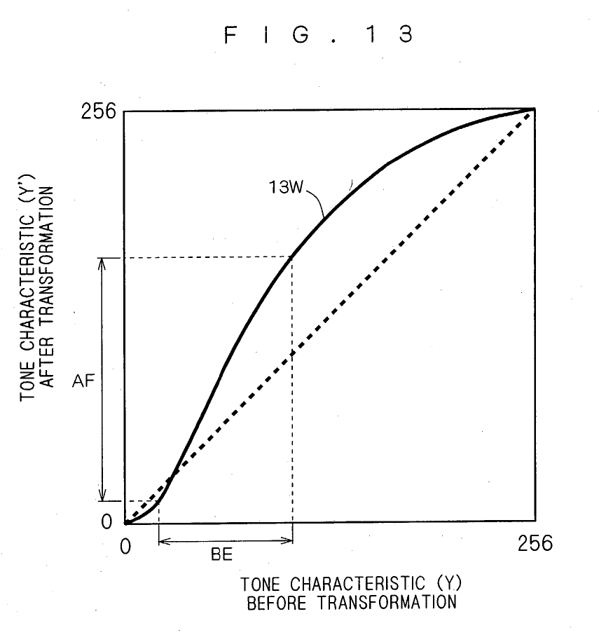

FIG. 12 is a schematic diagram showing a part of the information stored in the input image file IF. As shown in FIG. 12, the input image file IF has an area 12D for writing the input image data ID and a header area 12T for writing information accompanying the input image data ID. In the case where the device which has obtained the input image data ID is a digital camera, the model name (for example, CAMERA7) of the digital camera used, image capturing conditions (date and time of image capture, focal length, aperture, shutter speed, and so on), and the like are written in the header area 12T.

Therefore, in step S57, by referring to the address indicating the image capturing device such as the name of the digital camera from the header information of the input image file IF, the model name of the device which has obtained the input image data ID is recognized.

In step S58, whether or not the model name of the device which has obtained the input image data ID recognized in step S57 exists in the digital camera name list stored in the application AP is determined. If the model name of the device which has obtained the input image data ID exists in the digital camera name list stored in the application AP, the program advances to step S59. If the model name of the device which has obtained the input image data ID does not exist in the digital camera name list stored in the application AP, the program advances to step S61.

In step S59, since the model name of the device which has obtained the input image data ID exists in the digital camera name list stored in the application AP as determined in step S58, it is recognized that the device which has obtained the input image data ID is a digital camera, and the program advances to step S60.

In step S60, the profile information corresponding to the name of the model of the digital camera which has obtained the input image data ID recognized in step S57 is read from the storing unit 15 and stored into the memory 10b and the process of determining the image capturing device is finished. After that, the program advances to step S11 in FIG. 3.

In step S61, as determined in step S58, since the model name of the device which has obtained the input image data ID does not exist in the digital camera name list stored in the application AP, the device which has obtained the input image data ID is recognized as a device other than the digital camera, and the program advances to step S62.

In step S62, profile information corresponding to the model name of the device which has obtained the input image data ID recognized in step S57 is read from the storing unit 15 and stored in the memory 10b, and the process of determining the image capturing device is finished. After that, the program advances to step S11 in FIG. 3.

In step S111, whether the device which has obtained the input image data ID is a digital camera or not is determined on the basis of a result of the determination in step S10. If the device which has obtained the input image data ID is a digital camera, the program advances to step S12. If the device which has obtained the input image data ID is not a digital camera, the program advances to step S115.

As described above, on the basis of predetermined information such as information inputted by the user, profile information accompanying the input image data ID, or header information, it can be determined that the device which has obtained the input image data is a digital camera. Without deteriorating flexibility of using standardized information such as header information or ICC profile information attached to the input image data, whether the device which has obtained the input image data is a digital camera or not can be automatically determined.

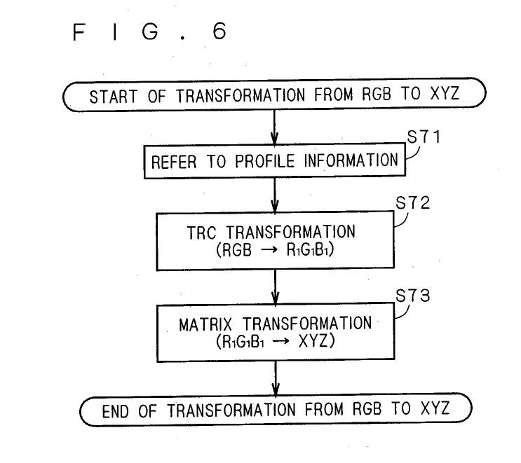

In step S12, the image data of the input image data ID is transformed from the image data in the RGB calorimetric system to image data in the XYZ colorimetric system and the program advances to step S13. The flow of a concrete process of transforming the calorimetric system of image data in step S12 is shown as another flowchart in FIG. 6.

When the program advances from step S11 to step S12, the process of transforming the calorimetric system of image data shown in FIG. 6 is started. After that, the program advances to step S71.

In step S71, TRC (Tone Reproduction Curve) tag information of profile information stored in the memory 10b is read and the program advances to step S72.

In step S72, by using the TRC tag information read in step S71, y correction is performed to correct nonlinearity of the tone characteristic of the input image data in the RGB colorimetric system, and the program advances to step S73.

In step S73, by using Colorant tag information in the profile information stored in the memory 10b, transformation from a device-dependent RGB colorimetric system to a device-independent XYZ calorimetric system is performed. After the process of transforming the image data from the RGB colorimetric system to image data in the XYZ colorimetric system is finished, the program advances to step S 13 in FIG. 3.

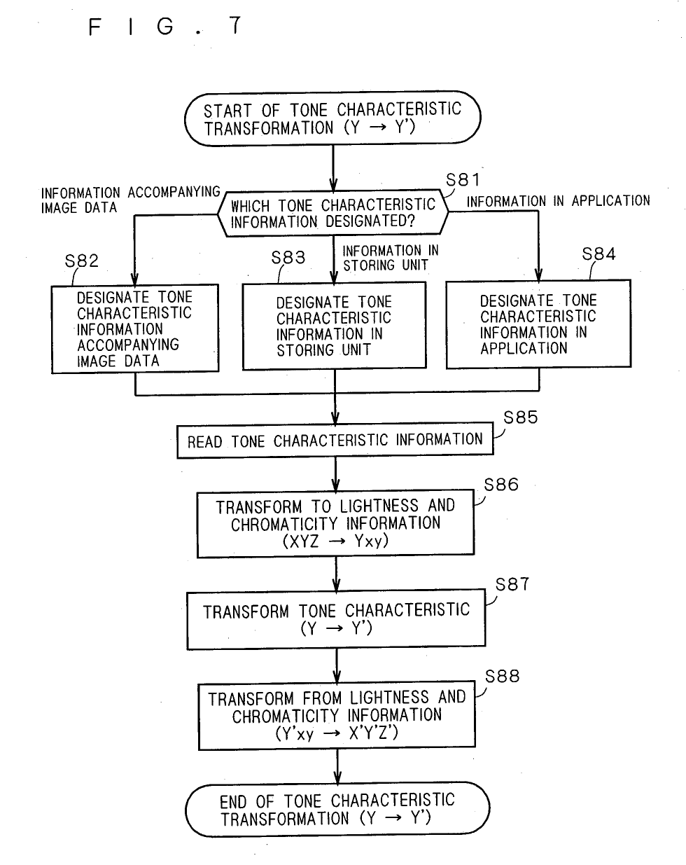

In step S13, a process of tone characteristic transformation (tone transformation) is performed on the image data transformed from the RGB colorimetric system to the XYZ calorimetric system in step S12, and the program advances to step S14. The flow of a concrete process of transforming the tone of the image data in step S13 is shown as another flowchart in FIG. 7.

When the program advances from step S12 to step S13, the process of transforming the tone characteristic of the image data shown in FIG. 7 is started, and the program advances to step S81.

In step S81, tone characteristic information to be subjected to the tone transforming process is designated. As shown in FIG. 2, there are three places where the tone characteristic information exists: (1) in the profile information accompanying the input image data ID; (2) in the profile information stored in the storing unit 15; and (3) in information stored in the application AP. According to the priority in order from (1) to (3), tone characteristic information used for tone transformation is designated. Specifically, if tone characteristic information corresponding to the model of the device which has obtained an image exists in the profile information accompanying the input image data ID, the program advances to step S82. If the tone characteristic information corresponding to the model of the device which has obtained an image does not exist in the profile information accompanying the input image data ID but exists in the profile information stored in the storing unit 15, the program advances to step S83. Further, if the tone characteristic information corresponding to the model of the device which has obtained the image does not exist in the profile information accompanying the input image data ID and in the profile information stored in the storing unit 15 but exists in information stored in the application AP, the program advances to step S84.

In step S82, tone characteristic information corresponding to the model of the device which has obtained an image in the profile information accompanying the input image data ID is designated as tone characteristic information used for tone transformation. After that, the program advances to step S85.

In step S83, tone characteristic information corresponding to the model of the device which has obtained an image in the profile information stored in the storing unit 15 is designated as tone characteristic information used for tone transformation, and the program advances to step S85.

In step S84, tone characteristic information in information stored in the application AP is designated as tone characteristic information used for tone transformation, and the program advances to step S85.

In step S85, on the basis of the designation in any of steps S82 to S84, tone characteristic information is read from any one of the profile information accompanying the input image data ID, profile information stored in the storing unit 15, and information in the application AP and stored into the memory 10b. After that, the program advances to step S86.

In step S86, the image data transformed in the XYZ calorimetric system in step S12 is transformed into light information Y and chromaticity information xy in accordance with the following Equations 1 to 3. After that, the program advances to step S87.

Y=Y (Equation 1)

x=X/(X+Y+Z) (Equation 2)

y=Y/(X+Y+Z) (Equation 3)

In step S87, tone transformation for transforming only the lightness information Y to lightness information Y′ on the basis of the tone characteristic information stored in the memory 10b in step S85 is performed, and the program advances to step S88. FIG. 13 is a schematic diagram showing tone characteristic information used for transforming the lightness information Y. In FIG. 13, the horizontal axis indicates the lightness information Y as a tone characteristic before transformation, the vertical axis indicates the lightness information Y′ as a tone characteristic after transformation, small numerical values indicate the shadow side and large numerical values indicate the highlight side. A curve 13W indicates the relationship between the lightness information Y before transformation and the lightness information Y′ after transformation.

As shown in FIG. 13, a tone range BE as a lightness range from shadow before transformation to a middle tone is transformed so as to be expressed by a wider tone range AF. Specifically, in step S87, tone transformation for enhancing the contrast in the lightness range from the shadow to the middle tone is performed. The chromaticity information xy is stored without being subjected to any change such as transformation.

In step S88, the lightness information Y′ subjected to tone transformation in step S87 and the chromaticity information xy which remains stored is transformed into image data indicated by X′Y′Z′ in the XYZ calorimetric system in accordance with Equations 4 to 6 and the process of transforming the tone characteristic of image data is finished. After that, the program advances to step S14 in FIG. 3.

X′=x·Y′/y (Equation 4)

Y′=Y′ (Equation 5)

Z′=(1−x−y)·Y′/y (Equation 6)

As described above, by performing tone transformation on the basis of the tone characteristic information corresponding to the model of the device which has obtained an image input from the outside of the control unit 10 (image processing apparatus), such as the tone characteristic information accompanying the input image data ID and the tone characteristic information stored in the storing unit 15, even when the image processing apparatus does not have tone characteristic information corresponding to the model of a digital camera which has obtained the input image data ID, tone transformation corresponding to a tone characteristic which varies according to the model of a device which has obtained the ID can be performed.

By performing the tone transformation on the basis of the tone characteristic information stored in the image processing apparatus, such as the tone characteristic information stored in the application AP, even when the tone characteristic information corresponding to the kind of a digital camera which has obtained the input image data ID is not inputted from the outside, intended tone transformation can be performed. Concretely, also in the case where a general image format and a general ICC profile and the like are used on the input image data ID, intended tone transformation can be performed.

Also in the case where the tone transformation is performed on the basis of tone characteristic information stored in the image processing apparatus, intended tone transformation can be performed. However, in order to perform tone transformation adapted to the tone characteristic varying according to a model which has obtained the input image data ID, it is more preferable to perform tone transformation on the basis of tone characteristic information corresponding to the model which has obtained an image, which is inputted from the outside of the image processing apparatus such as the tone characteristic information accompanying the input image data ID and the tone characteristic information stored in the storing unit 15. Consequently, the tone characteristic information used for tone transformation is designated according to the priority in order from (1) to (3).

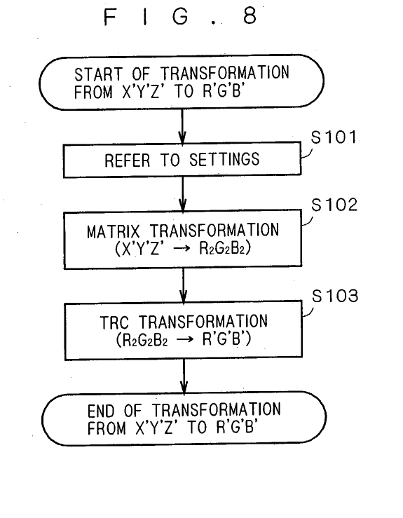

In step S14, transformation from the image data (X′Y′Z′) in the XYZ calorimetric system to image data (R′G′B′) in the RGB calorimetric system according to an output device is performed, and the program advances to step S 17. A flow of a concrete process of transforming image data in step S14 is shown as another flowchart in FIG. 8.

The program advances from step S13 to step S14 where the process of transforming image data from the XYZ calorimetric system to the RGB calorimetric system according to an output device as shown in FIG. 8 is started, and advances to step S101.

In step S101, the conditions set in step S1 are referred to and information of the output profile set in step S1 is read from the memory 10b. After that, the program advances to step S 102.

In step S102, Colorant tag information is called from the output profile information read in step S101 and transformation from the image data (X′Y′Z′) in the device-independent XYZ calorimetric system to image data (R₂G₂B₂) in the RGB colorimetric system according to an output device is performed. The program advances to step S 103.

In step S103, the TRC tag information is read from the output profile information, γ correction is performed on the image data (R₂G₂B₂) in the RGB calorimetric system, thereby generating image data (R′G′B′), the transformation of the image data from the XYZ colorimetric system to the RGB calorimetric system according to the output device is finished, and the program advances to step S17.

Next, description will be given of the flow of a process performed after it is determined in step S11 that the device which has obtained the input image data ID is not a digital camera and the program advances to step S115.

In step S15, in a manner similar to step S12, image data according to the input image data ID is transformed from the RGB calorimetric system to the XYZ colorimetric system, and the program advances to step S16. Herein, by using the TRC tag information in the profile information stored in the memory 10b in step S62, γ correction is performed to correct nonlinearity of the tone characteristic of the input image data in the RGB colorimetric system. By using the Colorant tag information in the profile information, transformation from the device-dependent RGB colorimetric system to the device-independent XYZ colorimetric system is performed.

In step S16, in a manner similar to step S14, transformation from the image data (XYZ) in the XYZ calorimetric system to image data (R″G″B″) in the RGB calorimetric system according to an output device is performed and, the program advances to step S17. To be specific, when it is not determined that the device which has obtained the input image data ID is a digital camera, without enhancing the contrast in the specific lightness range, a process similar to color matching performed by a conventional camera for a silver halide film, a scanner system, or the like is executed.

Next, description will be given of step S17 of performing a process of storing output image data.

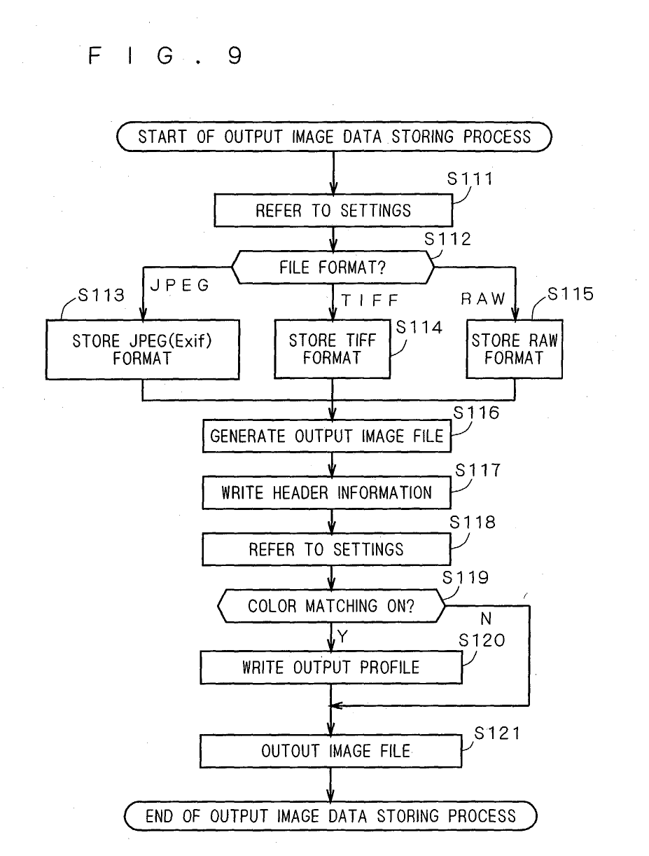

In step S17, a process of outputting image data to the outside of the application and storing the image data is performed, and the image process is finished. The flow of a concrete process in step S17 is shown as another flowchart in FIG. 9.

When the program advances from any of steps S9, S14 and S16 to step S17, the output image data storing process shown in FIG. 9 is started, and the program advances to step S 111.

In step S111, the setting of the output image file format stored in the memory 10b in step S1 is referred to, and the program advances to step S112.

In step S112, the output image file format referred in step S111 is determined. When it is determined that the output image file format is the JPEG(Exif) format, the program advances to step S113. When it is determined that the output image file format is the TIFF format, the program advances to step S114. When it is determined that the output image file format is the RAW format, the program advances to step S115.

In step S113, it is stored into the memory 10b that the output image file format is the JPEG(Exif) format, and the program advances to step S116.

In step S114, it is stored in the memory 10b that the output image file format is the TIFF format, and the program advances to step S116.

In step S115, it is stored in the memory 10b that the output image file format is the RAW format, and the program advances to step S1116.

In step S116, an output image file including output image data is generated according to the output image file format stored in the memory 10b in any of steps S 113 to S115 and stored into the memory 10b and, the program advances to step S117.

In step S117, header information of the image file according to the input image data ID stored in the memory 10b in step S7 is called and, according to the output image file format stored in any of steps S113 to S1115, header information is written into the output image file stored in the memory 10b in step S116. After that, the program advances to step S118.

In step S118, the conditions set in step S1 are referred to, setting indicating whether color matching is performed or not is read from the memory 10b, and the program advances to step S119.

In step S119, whether color matching is performed or not is determined. On the basis of the conditions which are set and stored in step S1, when the user selects execution of the color matching, the program advances to step S120. When the user does not select execution of the color matching, the program advances to step S121.

In step S120, according to the output image file format, the profile information of the output profile which is set in step S1 is written as information accompanying the output image data stored in the memory 10b and, the program advances to step S121. Specifically, a process such as writing of profile information of the output profile as tag information of the output image file is performed.

In step S121, the output image file stored in the memory 10b is transmitted and stored to the storing unit 15, and the output image data storing process is finished. After that, the operation of the image process is finished.

Herein, the output image data is stored in the storing unit 15. On the basis of various inputs via the operating unit 50 by the user, the output image data is outputted to the monitor 30, printer 40, storing medium 4a, or the like via the input/output I/F 21 under control of the control unit 10.

In the present embodiment as described above, when it is determined that the device which has obtained input image data is a digital camera on the basis of predetermined input information such as the information accompanying the input image data or information inputted by the user by the operation of the control unit 10 (image processing apparatus), the input image data is transformed to lightness and chromaticity information and tone transformation for enhancing the contrast in the lightness range from shadow to middle tone is performed without changing lightness, thereby generating output image data. Consequently, when input image data is data obtained by a digital camera, in consideration of the tone characteristics of the input image data, output image data which can be visually outputted with equivalent tone and color characteristic even from a different output device can be generated from input image data.

Modifications

Although the embodiments of the present invention have been described above, the present invention is not limited to the foregoing embodiments.

For example, in the above-described embodiments, the ICC profile corresponding to the digital camera name list and the tone characteristic information written in the application AP exists in the storing unit 15. However, the present invention is not limited thereto. The ICC profile corresponding to the digital camera name list and the tone characteristic information written in the application AP may exist in another personal computer, server or the like connected so as to be capable of transmitting data via a communication line, and the ICC profile corresponding to the model which has obtained an image and the tone characteristic information may be loaded into the personal computer 2 via the communication line.

Although the ICC profile is used as information for γ correction, tone transformation and the like in the above-described embodiments, the present invention is not limited thereto. As long as information is used for γ correction, tone transformation and the like, information of any data format may be used.

Although the XYZ calorimetric system is used for PCS (Profile Connection Space) in the above-described embodiments, the present invention is not limited thereto. The L*a*b* colorimetric system may be used for the PCS.

Although an application (program) stored in the storing unit 15 is loaded into the memory 10b of the control unit 10 in the personal computer 2 and executed by the CPU 10a to thereby perform the image process (which will be described later) in the above-described embodiments, the present invention is not limited thereto. The image processing apparatus may be formed by providing a dedicated processing circuit or the like.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus for generating output image data on the basis of input image data from an external device, comprising:
a determining part for determining whether said external device is a digital camera or not on the basis of predetermined input information;
a transforming part for transforming said input image data into lightness and chromaticity information when said external device is determined as a digital camera by said determining part; and
a generating part for generating said output image data by performing tone transformation for enhancing contrast in a specific lightness range on said lightness and chromaticity information without changing chromaticity.

2. The image processing apparatus according to claim 1, wherein
said generating part performs tone transformation for enhancing contrast in a lightness range from shadow to middle tone.

3. The image processing apparatus according to claim 1, wherein
said generating part performs tone transformation on the basis of tone characteristic information which is inputted from the outside of said image processing apparatus.

4. The image processing apparatus according to claim 1, wherein
said generating part performs tone transformation on the basis of tone characteristic information stored in said image processing apparatus.

5. The image processing apparatus according to claim 1, wherein
said determining part determines whether said external device is a digital camera or not on the basis of information accompanying said input image data.

6. A computer program product capable of making a computer built in an image processing apparatus for generating output image data on the basis of input image data from an external device execute a process comprising the following steps of:
(a) determining whether said external device is a digital camera or not on the basis of predetermined input information;
(b) transforming said input image data into lightness and chromaticity information when said external device is determined as a digital camera; and
(c) generating said output image data by performing tone transformation for enhancing contrast in a specific lightness range on said lightness and chromaticity information without changing chromaticity.

7. The computer program product according to claim 6, wherein
in said step (c), tone transformation for enhancing contrast in a lightness range from shadow to middle tone is performed.

8 The computer program product according to claim 6, wherein
in said step (c), tone transformation is performed on the basis of tone characteristic information which is inputted from the outside of said image processing apparatus.

9. The computer program product according to claim 6, wherein
in said step (c), tone transformation is performed on the basis of tone characteristic information stored in said image processing apparatus.

10. An image processing method of generating output image data on the basis of input image data from an external device, comprising the steps of:
(a) determining whether said external device is a digital camera or not on the basis of predetermined input information;
(b) transforming said input image data into lightness and chromaticity information when said external device is determined as a digital camera; and
(c) generating said output image data by performing tone transformation for enhancing contrast in a specific lightness range on said lightness and chromaticity information without changing chromaticity.

11. The image processing method according to claim 10, wherein
in said step (c), tone transformation for enhancing contrast in a lightness range from shadow to middle tone is performed.

12. The image processing method according to claim 10, wherein
in said step (c), tone transformation is performed on the basis of tone characteristic information which is inputted from the outside of said image processing apparatus.

13. The image processing method according to claim 10, wherein
in said step (c), tone transformation is performed on the basis of tone characteristic information stored in said image processing apparatus.

14. An image processing apparatus for generating output image data on the basis of input image data from an external device, comprising:
a determining part for determining whether said external device is a specific device or not on the basis of predetermined input information;
a transforming part for transforming said input image data into first image information and second image information when said external device is determined as said specific device by said determining part; and
a generating part for generating said output image data from said image information by modifying said second image information without changing said first image information.

15. The image processing apparatus according to claim 14, wherein
said specific device is an image capturing apparatus.

16. The image processing apparatus according to claim 14, wherein
said first and second image information is lightness information and chromaticity information, respectively.

17. The image processing apparatus according to claim 16, wherein
said generating part performs tone transformation for enhancing contrast in a specific lightness range without changing chromaticity.

18. The image processing apparatus according to claim 17, wherein
said generating part performs tone transformation for enhancing contrast in a lightness range from shadow to middle tone.

19. The image processing apparatus according to claim 17, wherein
said generating part performs tone transformation on the basis of tone characteristic information which is inputted from the outside of said image processing apparatus.

20. The image processing apparatus according to claim 17, wherein
said generating part performs tone transformation on the basis of tone characteristic information stored in said image processing apparatus.
